(19) United States
(12) Patent Application Publication
(10) Pub. No.: US 2025/0206123 A1
(43) Pub. Date: Jun. 26, 2025

(54) VEHICLE LOWER PART STRUCTURE

(71) Applicant: TOYOTA JIDOSHA KABUSHIKI KAISHA, Aichi-ken (JP)

(72) Inventors: Yasuhiro SHIRAI, Toyota-shi (JP); Hirokazu MAEDA, Nagoya-shi (JP); Junya MIYATAKE, Toyota-shi (JP); Yuki NISHIKAWA, Toyota-shi (JP); Katsuichiro HIRAKAWA, Seto-shi (JP)

(21) Appl. No.: 18/985,021

(22) Filed: Dec. 18, 2024

(30) Foreign Application Priority Data
Dec. 22, 2023 (JP) 2023-217397

(51) Int. Cl. B60K 1/04; B60L 50/60; B60R 22/22; B62D 25/20; H01M 50/249; H01M 50/262

(52) U.S. Cl. CPC B60K 1/04; B60L 50/66; B60R 22/22; B62D 25/2009; H01M 50/249; H01M 50/262; B60K 2001/0438; H01M 2220/20

(57) ABSTRACT

The disclosure provides a vehicle lower part structure. The vehicle lower part structure includes a battery case disposed on a vehicle lower side of a floor panel, a battery supporting portion supporting the battery case, and an anchor member mounted to a vehicle upper side of the battery supporting portion in a side view.

### CROSS-REFERENCE TO RELATED APPLICATION

This application claims priority to Japanese Patent Application No. 2023-217397 filed on Dec. 22, 2023, incorporated herein by reference in its entirety.

### BACKGROUND

### 1. Technical Field

The disclosure relates to a vehicle lower part structure.

### 2. Description of Related Art

A structure in which a reinforcement member is provided at a part to which a seatbelt anchor is attached in order to enhance stiffness against tension load input from a seatbelt to the seatbelt anchor is generally known (see, for example, Japanese Unexamined Patent Application Publication No. 2019-156088 (JP 2019-156088 A)).

### SUMMARY

However, if a reinforcement member for enhancing stiffness is provided at a part to which an anchor member, such as a seatbelt anchor, is attached, it leads to an increase in weight and an increase in manufacturing cost in a vehicle.

The disclosure provides a vehicle lower part structure capable of improving stiffness against load input to an anchor member while suppressing an increase in weight and an increase in manufacturing cost in a vehicle.

A first aspect of the disclosure provides a vehicle lower part structure. The vehicle lower part structure includes a battery case disposed on a vehicle lower side of a floor panel, a battery supporting portion supporting the battery case, and an anchor member mounted to a vehicle upper side of the battery supporting portion in a side view.

According to the first aspect, the battery case is disposed on the vehicle lower side of the floor panel, and the battery case is supported by the battery supporting portion. Then, the anchor member is mounted to the vehicle upper side of the battery supporting portion in a side view. Due to the battery case accommodating a battery that is a heavy load, load toward the vehicle lower side is constantly applied to the battery supporting portion.

Therefore, even when, for example, load toward a vehicle front side is input to the anchor member and the load toward the vehicle front side is transmitted to the battery supporting portion via the anchor member, the battery supporting portion easily withstands the load. In other words, according to the first aspect, stiffness against load input to the anchor member is improved while an increase in weight and an increase in manufacturing cost in a vehicle are suppressed.

In a vehicle lower part structure according to a second aspect of the disclosure, in addition to the vehicle lower part structure according to the first aspect, the battery supporting portion may include the floor panel, and a framework member mounted to the floor panel, and the battery supporting portion may have a closed cross-section structure made up of the floor panel and the framework member in a side view.

According to the second aspect, the battery supporting portion includes the floor panel and the framework member mounted to the floor panel, and the battery supporting portion has a closed cross-section structure made up of the floor panel and the framework member in a side view. Therefore, in comparison with a case where the battery supporting portion does not have a closed cross-section structure in a side view, the stiffness of the battery supporting portion is improved.

In a vehicle lower part structure according to a third aspect of the disclosure, in addition to the vehicle lower part structure according to the first aspect or the second aspect, the battery supporting portion and the battery case may be coupled to each other by a pair of support members, and a rigid-framed structure may be provided by the battery supporting portion, the pair of support members, and the battery case.

According to the third aspect, the battery supporting portion and the battery case are coupled to each other by the pair of support members. Thus, the rigid-framed structure is provided by the battery supporting portion, the pair of support members, and the battery case. Therefore, the body stiffness of the vehicle is effectively ensured.

In a vehicle lower part structure according to a fourth aspect of the disclosure, in addition to the vehicle lower part structure according to any one of the first to third aspects, the anchor member may be mounted to the vehicle upper side of the battery supporting portion by a fastening member.

According to the fourth aspect, the anchor member is mounted to the vehicle upper side of the battery supporting portion by the fastening member. Therefore, in comparison with a case where the anchor member is not mounted by fastening, for example, joined by adhesive or the like, load input to the anchor member is effectively received by the battery supporting portion.

In a vehicle lower part structure according to a fifth aspect of the disclosure, in addition to the vehicle lower part structure according to the fourth aspect, the anchor member may be a seatbelt anchor.

According to the fifth aspect, the anchor member is a seatbelt anchor. Therefore, even when load toward the vehicle front side is input to the seatbelt anchor, such as in the event of a frontal collision of the vehicle, the load is effectively received by the battery supporting portion.

In a vehicle lower part structure according to a sixth aspect of the disclosure, in addition to the vehicle lower part structure according to the fifth aspect, the seatbelt anchor may be used for a seatbelt for a rear seat.

According to the sixth aspect, the seatbelt anchor is used for a seatbelt for a rear seat. Therefore, even when load toward the vehicle front side is input to each of the seatbelt anchors by, for example, three occupants seated on a rear seat in the event of a frontal collision of the vehicle, or the like, each load is effectively received by the battery supporting portion.

As described above, according to the aspects of the disclosure, it is possible to improve stiffness against load input to the anchor member while suppressing an increase in weight and an increase in manufacturing cost in a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic side view that shows part of a vehicle including a vehicle lower part structure according to an embodiment;

FIG. 2 is a schematic side view that shows the vehicle lower part structure according to the embodiment; and

FIG. 3 is a schematic back view that shows the vehicle lower part structure according to the embodiment.

### DETAILED DESCRIPTION OF EMBODIMENTS

An embodiment according to the disclosure will be described in detail with reference to the accompanying drawings. For the sake of convenience of description, the arrow UP indicates a vehicle upward direction, the arrow FR indicates a vehicle forward direction, and the arrow RH indicates a direction to a vehicle right-hand side, shown as needed in the drawings. Therefore, in the following description, when upper and lower, front and rear, and right and left directions are mentioned unless otherwise specified, these are assumed to indicate upper and lower sides in a vehicle up and down direction, front and rear sides in a vehicle front and rear direction, and right and left sides in a vehicle right and left direction (vehicle width direction).

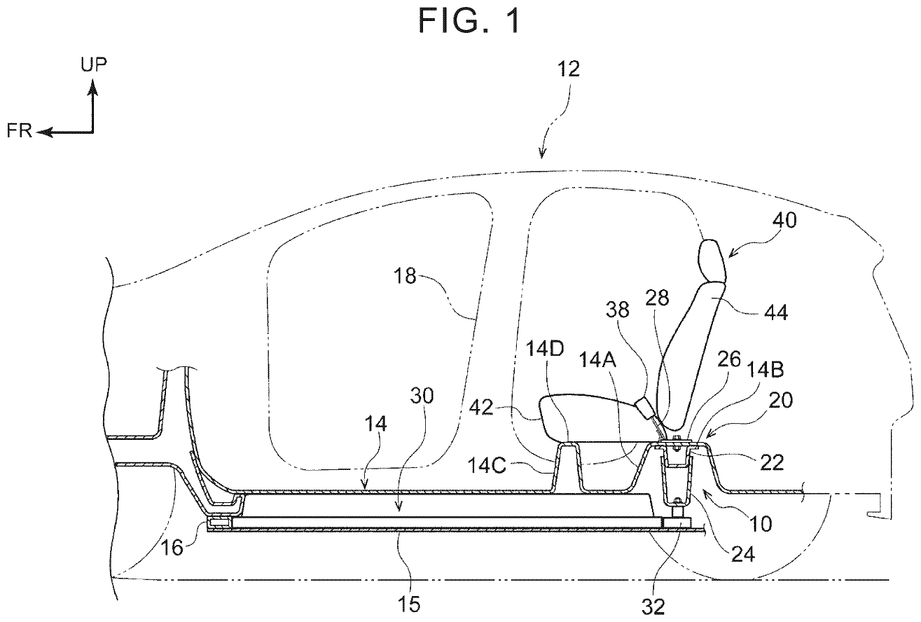

As shown in FIG. 1, in a vehicle 12 including a vehicle lower part structure 10 according to the present embodiment, a battery case 30 accommodating a battery that is a heavy load is disposed on the lower side of a floor panel 14. In other words, the vehicle 12 according to the present embodiment is a battery electric vehicle or a hybrid electric vehicle (plug-in hybrid electric vehicle).

A cross member 16 formed in a closed cross-sectional shape is mounted to the front side on the lower surface of the floor panel 14. A front end of the battery case 30 is supported by the cross member 16. The battery case 30 is formed in substantially a rectangular flat shape. A substantially rectangular flat-shaped under cover 15 is provided on the lower side of the battery case 30.

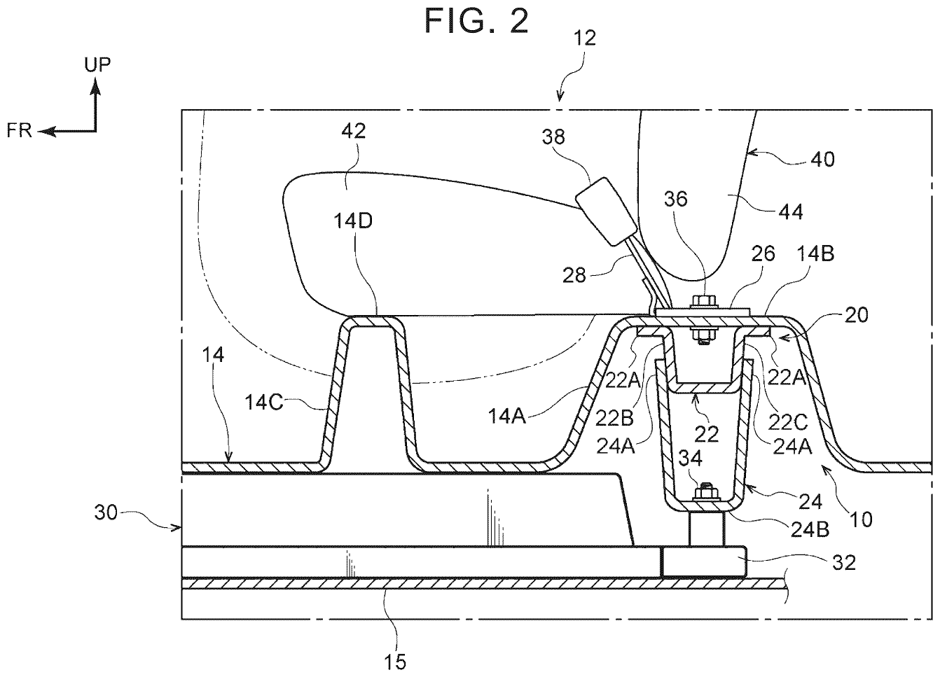

As shown in FIG. 1 and FIG. 2, an upright wall 14A and a rear upper wall 14B are formed at the rear side of the floor panel 14 in a side view when viewed in the vehicle width direction. The upright wall 14A is bent substantially at right angles toward the upper side along a wheel housing of a rear wheel. The rear upper wall 14B is bent from the upper end of the upright wall 14A toward the rear side and extends. Then, a cross member 22 serving as a framework member formed in substantially a hat shape in a side cross-sectional view is mounted to the lower surface of the rear upper wall 14B.

In other words, in a side view, front and rear flanges 22A at upper ends of the cross member 22 both are joined to the lower surface of the rear upper wall 14B by welding or the like, and a closed cross-section structure is provided by the rear upper wall 14B of the floor panel 14 and the cross member 22. The battery supporting portion 20 includes the rear upper wall 14B of the floor panel 14 and the cross member 22.

In a side view, part of the floor panel 14 on the front side with respect to the upright wall 14A and on the rear side with respect to a center pillar 18 is a supporting portion 14C formed to bend in substantially an inverted U-shape in a side cross-sectional view. The level of an upper wall 14D of the supporting portion 14C is substantially the same as the level of the rear upper wall 14B, and a seat cushion frame (seat cushion 42) of a vehicle seat 40 of a rear seat is supported by the upper wall 14D of the supporting portion 14C and the rear upper wall 14B.

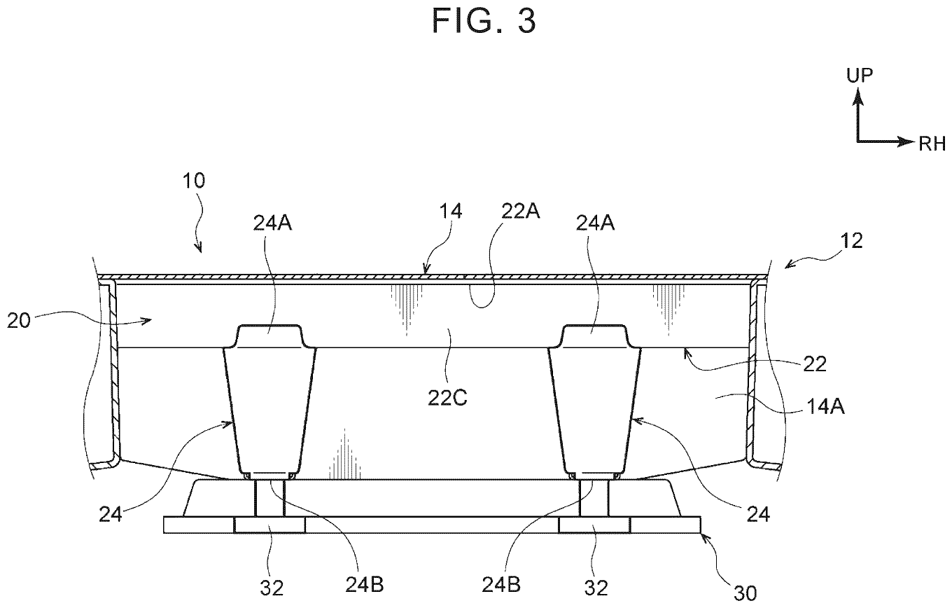

As shown in FIG. 2 and FIG. 3, support brackets 24 serving as a pair of right and left support members are mounted to the cross member 22 joined to the lower surface of the rear upper wall 14B of the floor panel 14. Each of the support brackets 24 is formed in substantially a U-shape in a side view. The front and rear upper ends 24A are respectively joined to a front wall 22B and a rear wall 22C of the cross member 22 by welding or the like.

Each of the support brackets 24 has substantially an isopoda trapezoidal shape such that the length of the upper end along the vehicle width direction in a back view is longer than the length of the lower end along the vehicle width direction. The support brackets 24 are disposed so as to be spaced apart from each other in the vehicle width direction. Then, a pair of right and left fixing parts 32 each formed in substantially an upward protruded shape in a back view is integrally formed with a rear end (rear part) of the battery case 30. Each of the fixing parts 32 is mounted (fastened) to the lower wall 24B of a fastening member 34, such as a bolt and a weld nut, is mounted to a lower wall 24B of a corresponding one of the support brackets 24.

In other words, the cross member 22 and the rear end (each of the fixing parts 32) of the battery case 30 are coupled to each other by a corresponding one of the support brackets 24, and a rigid-framed structure is provided by the cross member 22, the support brackets 24, and the rear end of the battery case 30 in a back view. In this way, the rear end of the battery case 30 is configured to be supported by the battery supporting portion 20 via the pair of right and left support brackets 24.

As shown in FIG. 2, in a side view, a flat-shaped seatbelt anchor 26 serving as an anchor member is mounted (fastened) by a fastening member 36, such as a bolt and a weld nut, to the upper surface of the rear upper wall 14B of the floor panel 14 between the front and rear flanges 22A of the cross member 22.

A slit through-hole (not shown) extending in the right and left direction is formed at a front end of the seatbelt anchor 26. One end of a webbing 28 is attached by being inserted through the through-hole. Then, a buckle 38 is attached to the other end of the webbing 28.

The seatbelt anchor 26 is used for a seatbelt for the vehicle seat 40 that is a nonsliding rear seat. Therefore, the seatbelt anchor 26 (the webbing 28 to which the buckle 38 is attached) is provided for each of seatbelts for occupants respectively seated on the vehicle seat 40 at the right and left sides of the rear seat and a seatbelt of an occupant seated on the vehicle seat 40 at the center, and the number of seatbelt anchors 26 is three.

In FIG. 1 and FIG. 2, the webbing 28 seems to be disposed to extend from the side of the seat cushion 42 of the vehicle seat 40 that is the rear seat to a vehicle cabin. Actually, the webbing 28 is disposed to extend from between the rear end of the seat cushion 42 and the lower end of the seat back 44 to the vehicle cabin.

Next, the operation of the vehicle lower part structure 10 according to the present embodiment configured as described above will be described.

As described above, the battery case 30 is disposed on the lower side of the floor panel 14, and the rear end (fixing parts 32) of the battery case 30 is supported by the battery supporting portion 20 via the pair of right and left support brackets 24. Then, in a side view, the seatbelt anchor 26 that supports the webbing 28 to which the buckle 38 is attached is mounted to the upper side of the battery supporting portion 20 by the fastening member 36 (in a side view, the upper surface of the rear upper wall 14B of the floor panel 14 between the front and rear flanges 22A of the cross member 22).

Due to the battery case 30 accommodating a battery that is a heavy load, load toward the vehicle lower side is constantly applied to the battery supporting portion 20. In other words, due to the battery case 30 accommodating a battery that is a heavy load, the battery supporting portion 20 is constantly pulled toward the lower side.

Therefore, even when, for example, load toward the front side (in detail, front upper side) is input to the seatbelt anchor 26 as a result of pulling of the webbing 28 toward the front side (in detail, front upper side) by an occupant (not shown) seated on the vehicle seat 40 that is a rear seat and fastening a seatbelt in the event of a frontal collision of the vehicle 12 or the like and the load toward the front side (in detail, front upper side) is transmitted to the battery supporting portion 20 via the seatbelt anchor 26, the battery supporting portion 20 easily withstands the load.

In other words, in a side view, even when no reinforcement member for enhancing stiffness is provided at the rear upper wall 14B of the floor panel 14 between the front and rear flanges 22A of the cross member 22, load input to the seatbelt anchor 26 can be effectively received by the battery supporting portion 20.

In this way, with the vehicle lower part structure 10 according to the present embodiment, it is possible to improve stiffness against load input to the seatbelt anchor 26 while suppressing or reducing an increase in weight and an increase in manufacturing cost in the vehicle 12 (while simplifying a body configuration of the vehicle 12).

In addition, the battery supporting portion 20 is configured to include the floor panel 14 and the cross member 22 mounted to the floor panel 14, and a closed cross-section structure is provided by the floor panel 14 and the cross member 22 in a side view. Therefore, in comparison with a case where the battery supporting portion 20 does not have a closed cross-section structure in a side view, it is possible to improve the stiffness of the battery supporting portion 20, so it is possible to sufficiently ensure withstanding force against load input.

The battery supporting portion 20 and the rear end of the battery case 30 are coupled to each other by the pair of right and left support brackets 24, and a rigid-framed structure is formed by the battery supporting portion 20, the pair of right and left support brackets 24, and the rear end of the battery case 30. Therefore, body stiffness at least at the rear of the vehicle 12 can also be effectively ensured.

The seatbelt anchor 26 is mounted to the upper side of the battery supporting portion 20 by the fastening member 36. Therefore, in comparison with a case where the seatbelt anchor 26 is mounted not by fastening, for example, in comparison with a case where the seatbelt anchor 26 is joined by an adhesive or the like, load input to the seatbelt anchor 26 can be effectively received by the battery supporting portion 20.

The seatbelt anchor 26 is used for a seatbelt for the vehicle seat 40 that is a nonsliding rear seat. Therefore, even when load toward the front side (in detail, front upper side) is input to the seatbelt anchors 26 by, for example, three occupants (not shown) seated on the vehicle seat 40 that is a rear seat and each fastening a seatbelt in the event of a frontal collision of the vehicle 12 or the like, the load from each occupant can be effectively received by the single battery supporting portion 20.

The vehicle lower part structure 10 according to the present embodiment has been described with reference to the accompanying drawings; however, the vehicle lower part structure 10 according to the present embodiment is not limited to the illustrated one. The design of the vehicle lower part structure 10 according to the present embodiment may be changed as needed without departing from the scope of the disclosure. For example, the anchor member is not limited to the seatbelt anchor 26. The same applies to a case of a child seat anchor (not shown).

Examples of the anchor member include a seatbelt anchor that fixes a wheelchair. Therefore, the battery supporting portion 20 can be provided at a middle part or the like of the floor panel 14 in the front and rear direction. In this case, the lower walls 24B of the pair of right and left support brackets 24 are respectively mounted to, for example, right and left sides or the like of the battery case 30.

What is claimed is:

1. A vehicle lower part structure comprising:
a battery case disposed on a vehicle lower side of a floor panel;
a battery supporting portion supporting the battery case; and
an anchor member mounted to a vehicle upper side of the battery supporting portion in a side view.

2. The vehicle lower part structure according to claim 1, wherein:
the battery supporting portion includes the floor panel, and a framework member mounted to the floor panel; and
the battery supporting portion has a closed cross-section structure made up of the floor panel and the framework member in a side view.

3. The vehicle lower part structure according to claim 2, wherein:
the battery supporting portion and the battery case are coupled to each other by a pair of support members; and
a rigid-framed structure is provided by the battery supporting portion, the pair of support members, and the battery case.

4. The vehicle lower part structure according to claim 1, wherein the anchor member is mounted to the vehicle upper side of the battery supporting portion by a fastening member.

5. The vehicle lower part structure according to claim 4, wherein the anchor member is a seatbelt anchor.

6. The vehicle lower part structure according to claim 5, wherein the seatbelt anchor is used for a seatbelt for a rear seat.
